(19) United States
(12) Patent Application Publication
(10) Pub. No.: US 2011/0121640 A1
(43) Pub. Date: May 26, 2011

(54) RAIL VEHICLE BRAKE CONTROL DEVICE

(76) Inventors: Etsuji Matsuyama, Tokyo (JP); Yasuharu Itano, Tokyo (JP)

(21) Appl. No.: 13/055,524

(22) PCT Filed: Oct. 21, 2008
(86) PCT No.: PCT/JP2008/069050

§ 371 Date: Jan. 24, 2011

(51) Int. Cl. B61H 13/20; B60T 13/68; B60T 13/00; B60T 13/74; B61H 13/00

(52) U.S. Cl. 303/3; 303/7; 303/2

(57) ABSTRACT

A rail vehicle brake control device includes a brake control unit that is mounted on each truck and generates a pressure control signal for controlling a brake cylinder pressure that acts on a brake cylinder based on a service brake command and an emergency brake command, an electromagnetic valve unit that includes a brake control valve that adjusts a pressure of compressed air supplied to the brake cylinder according to the pressure control signal, and a relay valve that outputs the brake cylinder pressure corresponding to the compressed air supplied from the electromagnetic valve unit. The electromagnetic valve unit includes a release isolation magnet valve that adjusts a pressure of the compressed air supplied to a primary side of the relay valve, and the release isolation magnet valve is operated by receiving power source supply from a brake control device mounted on another truck.

### TECHNICAL FIELD

The present invention relates to a rail vehicle brake control device.

### BACKGROUND ART

A rail vehicle brake control device (hereinafter, “brake control device”) that controls a brake cylinder pressure acting on a brake cylinder of each axle is utilized in rail vehicles. The brake control device includes a brake control unit that generates a pressure control signal for controlling a brake cylinder pressure based on a service brake command and an emergency brake command; an electromagnetic valve unit that includes a brake control valve that adjusts a pressure of compressed air supplied to a brake cylinder according to a pressure control signal; and a relay valve that outputs a brake cylinder pressure corresponding to compressed air supplied from the electromagnetic valve unit. The pressure control signal is generated by an electromagnetic-valve drive circuit in the brake control unit using a circuit power source in the brake control unit as a supply source, and is output to a solenoid of the electromagnetic valve unit. According to the brake control device with such a configuration, at a time of power running, the electromagnetic valve unit receives power source supply from the circuit power source to be excited and then a brake force is released. At a time of service braking, the power source supply to the electromagnetic valve unit is performed or stopped, so that a predetermined brake force is output. On the other hand, when an emergency brake command is output, the power source supply of the circuit power source to the electromagnetic valve unit is forcibly stopped, so that emergency braking can be generated.

Conventionally, for example, a brake control device described in Patent Document 1 mentioned below includes a brake control unit that outputs a pressure control signal corresponding to a brake command output from a brake command unit; a relay valve to which compressed air is supplied from an air storage; a brake cylinder that generates a brake force by the compressed air; and an electromagnetic valve unit that is mounted between the relay valve and the brake cylinder and controls a brake cylinder pressure in response to the brake command. In this brake control device, the electromagnetic valve unit is placed between the relay valve and the brake cylinder, so that the brake cylinder pressure is directly controlled by the electromagnetic valve unit. With this configuration, control errors in the relay valve can be reduced and the accuracy of brake control can be improved.

Patent Document 1: Japanese Patent Application Laid-open No. 2001-018784

### DISCLOSURE OF INVENTION

### Problem To Be Solved By The Invention

However, according to a conventional brake control device represented by the device described in Patent Document 1, when the brake control unit is broken or when some power source cards of the brake control device are broken and consequently the circuit power source supplied to the electromagnetic valve unit is lowered, brake control by a service brake cannot be performed and an emergency brake has to be used instead.

In addition, it has been difficult to satisfy the demand from railway companies for continuing brake control by a service brake as far as possible, only by brake control by an emergency brake.

The present invention has been made in view of the above problems, and an object of the present invention is to provide a brake control device that can perform brake control by a service brake even when a brake control unit is broken or a circuit power source for the brake control device is lowered.

### Means For Solving Problem

A rail vehicle brake control device according to an aspect of the present invention includes: a brake control unit that is mounted on each truck and generates a pressure control signal for controlling a brake cylinder pressure that acts on a brake cylinder based on a service brake command and an emergency brake command; an electromagnetic valve unit that includes a brake control valve that adjusts a pressure of compressed air supplied to the brake cylinder according to the pressure control signal; and a relay valve that outputs a brake cylinder pressure corresponding to the compressed air supplied from the electromagnetic valve unit, wherein the electromagnetic valve unit includes a release isolation magnet valve that adjusts a pressure of compressed air supplied to a primary side of the relay valve, and the release isolation magnet valve is configured to be operated by receiving power source supply from a brake control device mounted on another truck.

### EFFECT OF THE INVENTION

The brake control device according to the present invention includes an electromagnetic-valve drive circuit that has an emergency relay, a release isolation magnet valve control relay, and a circuit-power-source supply relay and a release isolation magnet electromagnetic valve. The release isolation magnet valve mounted on one truck is operated by receiving circuit-power-source supply from a circuit-power-source supply relay mounted on another truck. Therefore, even when a brake control unit is broken or a circuit power source of the brake control device is lowered, brake control can be performed by a service brake.

### BRIEF DESCRIPTION OF DRAWINGS

FIG. 1 is an example of a configuration of a brake control device according to a first embodiment.

FIG. 2 depicts an operation of a release isolation magnet valve when compressed air is supplied.

FIG. 3 depicts an operation of the release isolation magnet valve when compressed air is exhausted.

FIG. 4 is an example of a configuration of an electromagnetic-valve drive circuit.

FIG. 5 is an example of a configuration of an electromagnetic-valve drive circuit that controls a release isolation magnet valve of a first brake control device.

FIG. 6 is an example of a configuration of a brake control unit connected through a train information management system.

FIG. 7 is an example of a configuration of a brake control unit that includes a circuit-power-source switching unit composed of an OR circuit.

FIG. 8 is an example of a configuration of a brake control unit that includes a circuit-power-source switching unit composed of a switch circuit.

### EXPLANATIONS OF LETTERS OR NUMERALS

10 Service brake command

11 Brake network

12 Emergency brake command

13 Supply storage

14 Pneumatic spring pressure

15 Output pressure

16 Pressure control signal

17 Compressed air

18 Brake cylinder pressure

20 Brake control unit

20a Brake control unit of first brake control device

20b Brake control unit of second brake control device

21 Variable load valve

22 Brake control valve/slide control valve

23 Release isolation magnet valve (RIMV)

24 Relay valve

25, 26 Pressure sensor

27 Brake cylinder

28 Electromagnetic valve unit

30, 30a, 30b Electromagnetic-valve drive circuit

31 Release isolation magnet valve power source line (RIMV power source line)

32 Emergency relay

33 Release isolation magnet valve control relay (RIMV control relay)

34 Circuit-power-source supply relay

40, 41 Circuit-power-source switching unit

42 Train information management system

100 Brake control device

P1 Circuit power source (first circuit power source)

P2 Circuit power source (second circuit power source)

### BEST MODE(S) FOR CARRYING OUT THE INVENTION

Exemplary embodiments of a brake control device according to the present invention will be explained below in detail with reference to the accompanying drawings. The present invention is not limited to the embodiments.

### First Embodiment

### (Configuration of Brake Control Device)

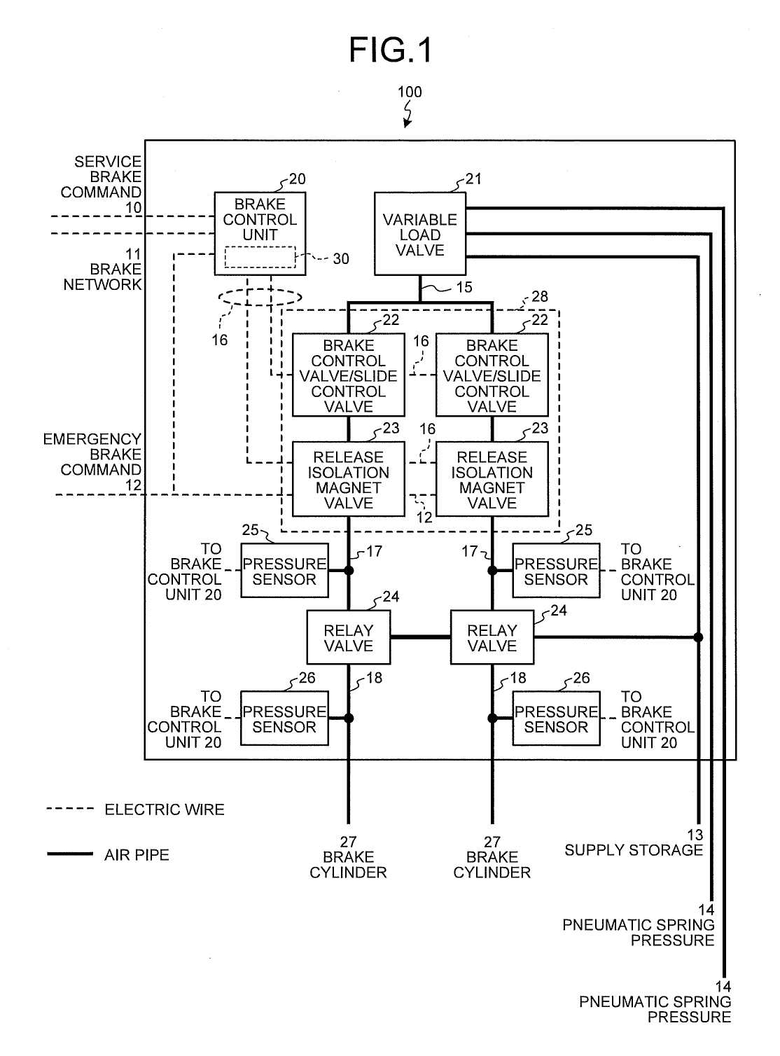

FIG. 1 is an example of a configuration of a brake control device according to a first embodiment. A brake control device 100 shown in FIG. 1 includes, as main constituent elements, a brake control unit 20, a variable load valve 21, a brake control valve/slide control valve 22, a release isolation magnet valve (RIMV) 23, a relay valve 24, a pressure sensor 25, and a pressure sensor 26.

The brake control unit 20 has an electromagnetic-valve drive circuit 30, and the electromagnetic-valve drive circuit 30 controls the brake control valve/slide control valve 22 and the RIMV 23. The brake control unit 20 is connected to the brake control device 100 mounted on another truck (not shown) through a brake network 11 described later. A service brake command 10 and an emergency brake command 12 output from a brake command unit (not shown) are input to the brake control unit 20. Further, a predetermined mode in which supply of compressed air and exhaust thereof are combined with each other for service brake control, slide control, and emergency brake outputting is defined in the brake control unit 20. Therefore, the electromagnetic-valve drive circuit 30 in the brake control unit 20 outputs a pressure control signal 16 for controlling a brake cylinder pressure 18 that acts on a brake cylinder 27 based on the service brake command 10, the emergency brake command, and the predetermined mode. Thus, the electromagnetic-valve drive circuit 30 controls the brake control valve/slide control valve 22 and the RIMV 23. The RIMV 23 controlled by the electromagnetic-valve drive circuit 30 is described later.

The variable load valve 21 is mounted on each truck and supplies an output pressure 15 corresponding to a pneumatic spring pressure 14, which is obtained by detecting a weight of a vehicle, to the brake control valve/slide control valve 22.

The brake control valve/slide control valve 22 adjusts the output pressure 15 described above based on the pressure control signal 16 output from the brake control unit 20. The brake control valve/slide control valve 22 generally includes a plurality of electromagnetic valves such as an apply magnet valve that supplies the supplied output pressure 15 to the brake cylinder 27 and a release magnet valve that adjusts the supplied output pressure 15.

The relay valve 24 is used for improving responsiveness of the brake cylinder pressure 18. Compressed air 17 output from the brake control valve/slide control valve 22 is input to a primary side of the relay valve 24, and a supply storage 13 that stores compressed air of a predetermined pressure is connected thereto. Therefore, the relay valve 24 can output the brake cylinder pressure 18 corresponding to the compressed air 17 described above.

The pressure sensor 25 detects the compressed air 17 input to the relay valve 24 and the pressure sensor 26 detects the brake cylinder pressure 18 output from the relay valve 24. The pressure sensors 25 and 26 then generate feedback commands (not shown) to feedback these feedback commands to the brake control unit 20. Therefore, the brake control unit 20 can perform accurate calculations of the pressure control signal 16.

The brake cylinder 27 presses a brake shoe (not shown) of a predetermined friction coefficient against each wheel according to an intensity of the brake cylinder pressure 18 to generate a desired brake force.

The RIMV 23 adjusts a pressure on the primary side of the relay valve 24 and exhausts the pressure put in the brake cylinder 27 after emergency braking is generated to release the brake force.

In FIG. 1, brake control valve/slide control valves 22, RIMVs 23, and relay valves 24 are shown symmetrically with respect to the variable load valve 21 for controlling individually brakes of respective axles. For example, the brake control valve/slide control valve 22, the RIMV 23, and the relay valve 24 on the left side of the variable load valve 21 adjust the brake cylinder pressure 18 of one brake cylinder 27. The brake control valve/slide control valve 22, the RIMV 23, and the relay valve 24 on the right side of the variable load valve 21 adjust the brake cylinder pressure 18 of the other brake cylinder 27. The brake control valve and the RIMV 23 that adjust the pressure of the compressed air 17 based on the service brake command 10 as well as the emergency brake command 12 are referred to as an electromagnetic valve unit 28.

(Operation of release isolation magnet valve)

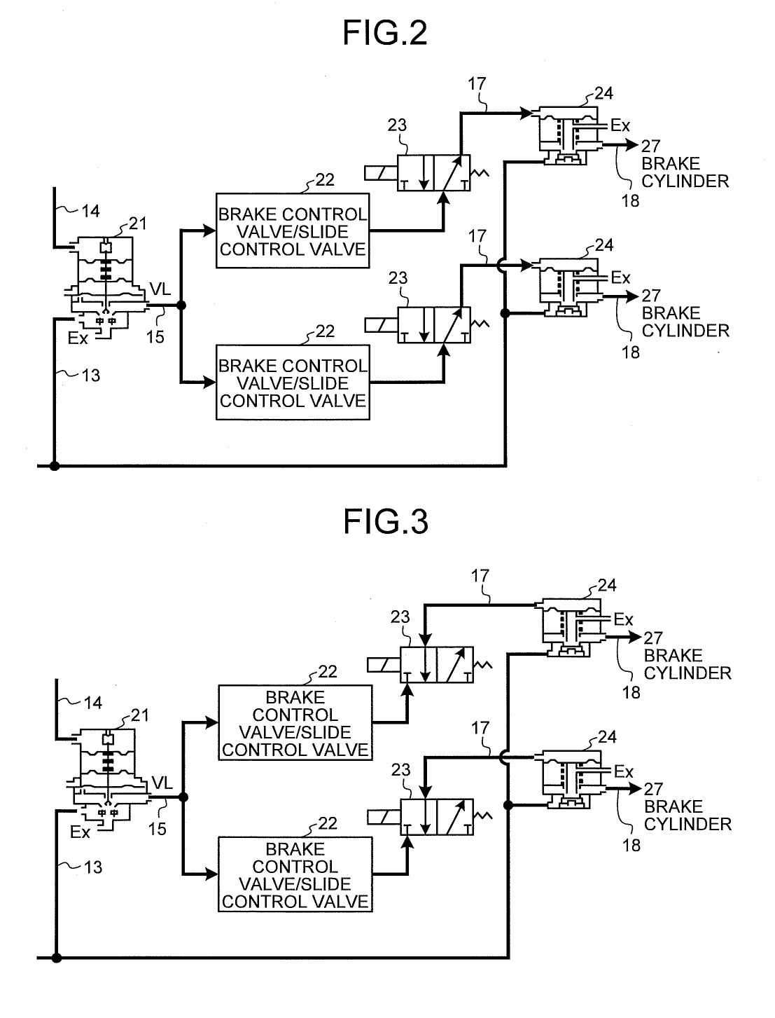

FIG. 2 depicts an operation of a release isolation magnet valve when compressed air is supplied. FIG. 3 depicts an operation of the release isolation magnet valve when compressed air is exhausted. With reference to FIGS. 2 and 3, solid lines between electromagnetic valves, that is, the variable load valve 21, the brake control valve/slide control valve 22, the RIMV 23, and the relay valve 24 represent a route through which compressed air passes through.

As shown in FIG. 2 or FIG. 3, the RIMV 23 is a three way valve that includes an inlet for compressed air output from the brake control valve/slide control valve 22, an outlet for sending the compressed air to the relay valve 24, and an exhaust port for exhausting the pressure put in the brake cylinder 27.

Further, the RIMV 23 is configured to be moved forward or backward in an extension direction of a spring in the RIMV 23 according to an urging force of the spring because of excitation or demagnetization of a solenoid of the RIMV 23 by a release isolation magnet valve control relay (RIMV control relay) 33 described later.

In FIG. 2, when the solenoid is demagnetized, an operating position of the RIMV 23 is held at a position where the compressed air 17 output from the brake control valve/slide control valve 22 passes toward the relay valve 24. In this case, the relay valve 24 supplies the brake cylinder pressure 18 to the brake cylinder 27. That is, a brake force is increased when power source supply from the circuit power source to the RIMV 23 is stopped.

On the other hand, when the solenoid is excited, the operating position of the RIMV 23 is held at a position where the compressed air 17 output from the relay valve 24 is externally exhausted as shown in FIG. 3. In this case, the relay valve 24 can exhaust the brake cylinder pressure 18 put in the brake cylinder 27. That is, the brake force is weakened when the power source supply from the circuit power source to the RIMV 23 is performed.

Because the variable load valve 21, the brake control valve/slide control valve 22, and the relay valve 24 shown in FIGS. 2 and 3 are well known, explanations of their operations will be omitted. The electromagnetic-valve drive circuit 30 that controls the RIMV 23 is described below.

### (Detailed Configuration of Brake Control Device)

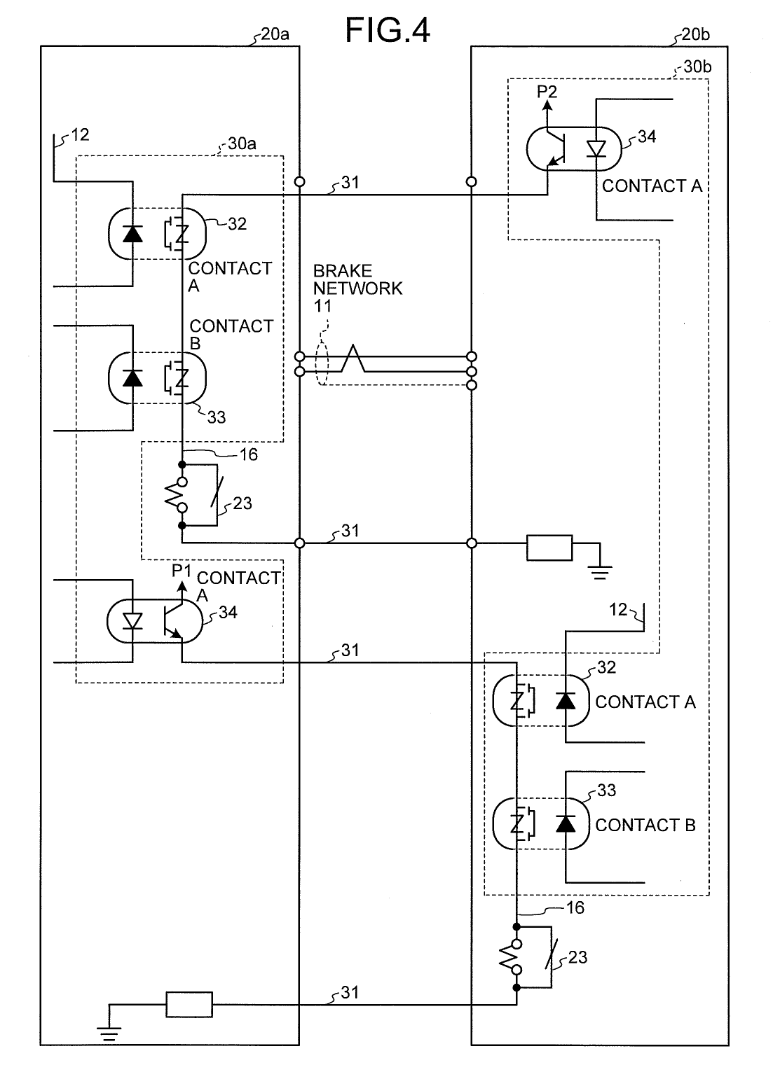

FIG. 4 is an example of a configuration of the electromagnetic-valve drive circuit. A brake control unit 20a and a brake control unit 20b shown in FIG. 4 represent the brake control unit 20 of the brake control device 100 mounted on each truck. For example, the brake control unit 20a is incorporated in the brake control device (hereinafter, “first brake control device”) 100 mounted on one truck of a vehicle. The brake control unit 20b is incorporated in the brake control device (hereinafter, “second brake control device”) 100 mounted on the other truck of the vehicle. Further, it is assumed that electromagnetic-valve drive circuits 30a and 30b are incorporated in the brake control units 20a and 20b, respectively.

### (Electromagnetic-Valve Drive Circuit)

The electromagnetic-valve drive circuits 30a and 30b include, as main constituent elements, a circuit-power-source supply relay 34, an emergency relay 32, and the RIMV control relay 33. Further, circuit power sources P1 and P2 that are supplied to solenoids of the respective RIMV 23 through the relays are connected to the electromagnetic-valve drive circuits 30a and 30b, respectively. The circuit power source P1 or P2 is shown as the pressure control signal 16 for controlling the RIMV 23 in FIGS. 1 and 4.

### (Brake Network)

The brake network 11 monitors a state of the brake control device 100 mounted on each truck. When the circuit power source P1 is lowered or the brake control unit 20a is broken in the first brake control device 100, the brake network 11 outputs information on the lowering in the circuit power source P1 and the failure of the brake control unit 20a to the second brake control device 100 as failure information. That is, the brake control device 100 mounted on each truck can transmit and receive the failure information of each brake control unit through the brake network 11. with reference to FIG. 4, while the brake network 11 uses a twist pair cable denoted by two solid lines and one dashed line, cables with a same function as that of the twist pair cable can be also used.

(Release isolation magnet valve power source line)

A release isolation magnet valve power source line (hereinafter, “RIMV power source line”) 31 is a power source cable that is laid between vehicles or in each vehicle and supplies a power source of the circuit power source P1 or P2 to the RIMV 23 between the brake control devices 100 mounted on the trucks. Because an output end of the circuit-power-source supply relay 34 described above is connected to the RIMV power source line 31, the power source of the circuit power source P2 for the second brake control device 100 can be supplied to the RIMV 23 mounted on the first brake control device 100.

### (Circuit-Power-Source Supply Relay)

The circuit-power-source supply relay 34 is composed of a contact A and operates this contact in response to a command (not shown) from the brake control unit 20a or the brake control unit 20b so that the power source of the circuit power source P1 or P2 is supplied to the RIMV 23 or the supply of the power source of the circuit power source P1 or P2 to the RIMV 23 is stopped.

### (RIMV Control Relay)

The RIMV control relay 33 is composed of a contact B and operates this contact in response to a command (not shown) from the brake control unit 20a or the brake control unit 20b so that the power source of the circuit power source P1 or P2 is supplied to the RIMV 23 or the supply of the power source of the circuit power source P1 or P2 to the RIMV 23 is stopped.

### (Emergency Relay)

The emergency relay 32 is composed of the contact A and stops the supply of the power source of the circuit power source P1 or P2 to the RIMV 23 based on the emergency brake command 12. Specifically, when the emergency brake command 12 is not output, the emergency relay 32 is conducted (CLOSE). On the other hand, when the emergency brake command 12 is output, the emergency relay 32 is not conducted (OPEN). In the case that the emergency brake command 12 is output, even when the power source of the circuit power source P1 or P2 is supplied from the circuit-power-source supply relay 34 to the RIMV 23, the emergency relay 32 stops the supply of the power source of the circuit power source P1 or P2 to the RIMV 23. Consequently, the relay valve 24 can supply the brake cylinder pressure 18 corresponding to emergency braking to the brake cylinder 27.

When the circuit power source P1 is lowered or the brake control unit 20a is broken in the first brake control device 100, all electromagnetic valves in the electromagnetic-valve drive circuits 30a and 30b are demagnetized and the circuits become a brake mode.

However, even in the brake mode, the circuit-power-source supply relay 34 mounted on the second brake control device 100 can supply the power source of the circuit power source P2 to the RIMV 23 of the first brake control device 100. Therefore, the first brake control device 100 can release a brake.

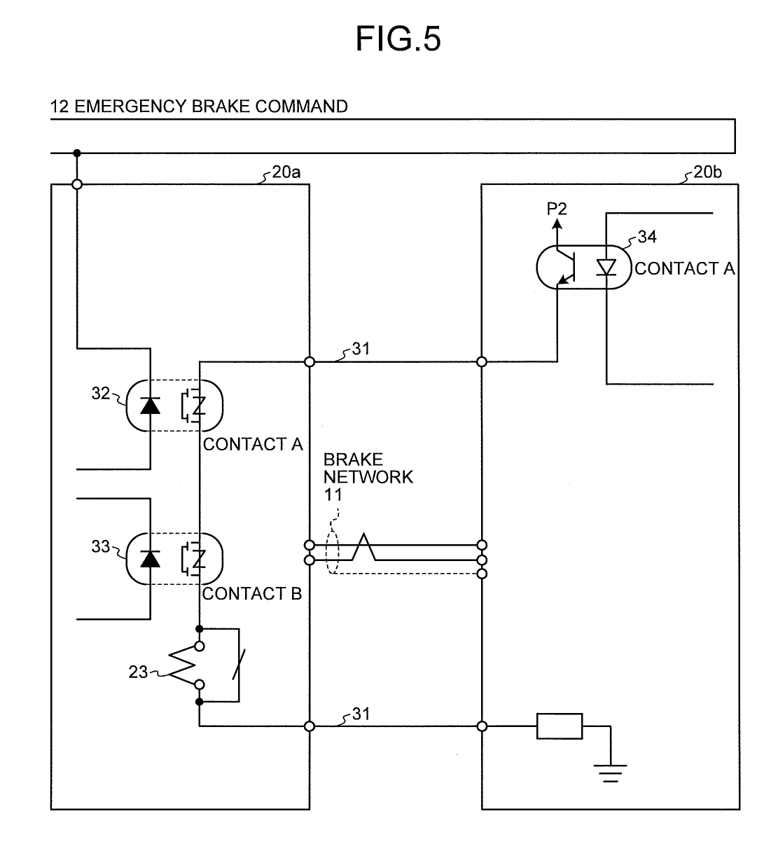

FIG. 5 is an example of a configuration of an electromagnetic-valve drive circuit that controls a release isolation magnet valve of the first brake control device. A configuration of the brake control units 20a and 20b when the RIMV 23 mounted on the first brake control device 100 is controlled by using the circuit-power-source supply relay 34 mounted on the second brake control device 100 is specifically shown in FIG. 5.

### (Operation During Normal Time)

An operation of the RIMV 23 when the circuit power source P1 is not lowered or the brake control unit 20a is not broken in the first brake control device 100 is described first. When the emergency brake command 12 is not output in a state that the RIMV control relay 33 is conducted, the emergency relay 32 is conducted (CLOSE). In such a state, when the circuit-power-source supply relay 34 is conducted (CLOSE) and the power source of the circuit power source P2 is supplied to the RIMV 23, the relay valve 24 exhausts the brake cylinder pressure 18.

On the other hand, when the emergency brake command 12 is output in a state that the RIMV control relay 33 is conducted, the emergency relay 32 is changed to be non-conductive (OPEN). In this case, the power source of the circuit power source P2 is not supplied to the RIMV 23 regardless of the state of the circuit-power-source supply relay 34. As a result, the relay valve 24 supplies the brake cylinder pressure 18 corresponding to emergency braking to the brake cylinder 27.

### (Operation During Failure)

An operation when the circuit power source P1 is lowered or the brake control unit 20a is broken in the first brake control device 100 is described next. When the circuit power source P1 is lowered or the brake control unit 20a is broken in the first brake control device 100, all electromagnetic valves are demagnetized for safety operation and the RIMV 23 supplies the brake cylinder pressure 18. Even in such a state, when the circuit-power-source supply relay 34 mounted on the brake control unit 20b is excited and the contact of the circuit-power-source supply relay 34 is conducted (CLOSE), the power source of the circuit power source P2 is supplied to the RIMV 23. As a result, the relay valve 24 exhausts the brake cylinder pressure 18.

### (Operation During Emergency Braking)

Further, when the emergency brake command 12 is output in a state that the brake cylinder pressure 18 is exhausted, the emergency relay 32 is not conduced (OPEN). Accordingly, regardless of whether the circuit power source P1 is lowered or the brake control unit 20a is broken in the first brake control device 100, or of a state of the contact of the circuit-power-source supply relay 34, the supply of the power source of the circuit power source P2 to the RIMV 23 is stopped. As a result, the relay valve 24 can supply the brake cylinder pressure 18 corresponding to emergency braking to the brake cylinder 27. That is, the brake control device 100 mounted on each truck is configured to be always operated safely when the emergency brake command 12 is output.

As described above, according to the brake control device 100 of the first embodiment, the power source of the circuit power source P2 can be supplied to RIMV 23 of the first brake control device 100 or this power source supply can be stopped by using the circuit-power-source supply relay 34 of the second brake control device 100. That is, the brake control device 100 is configured to remotely control the RIMV 23 by the circuit-power-source supply relay 34. When the circuit power source P1 is lowered or the brake control unit 20a is broken in the first brake control device 100, brake control by the service brake command 10 as well as brake control by the emergency brake command 12 can be performed.

As explained above, the brake control device 100 according to the first embodiment includes the electromagnetic-valve drive circuit 30 that has the emergency relay 32, the RIMV control relay 33, and the circuit-power-source supply relay 34 as well as the release isolation magnet valve 23. The release isolation magnet valve 23 is operated by supplied the circuit power source P2 from the circuit-power-source supply relay 34 mounted on another truck. Therefore, even when the circuit power source P1 is lowered or the brake control unit 20a is broken in the first brake control device 100, the brake cylinder pressure 18 can be controlled. Therefore, even when the circuit power source P1 is lowered or the brake control unit 20a is broken in the first brake control device 100 and thus the device is in the brake mode, a brake can be released thereafter. With this configuration, undesired abrasion and heat generation of a brake shoe when a rail vehicle is pulled can be prevented and the rail vehicle can be transported in a stable manner. On top of that, when a brake force is insufficient, it can be increased. In addition, when the emergency brake command 12 is output, the rail vehicle can be stopped.

### Second Embodiment

The brake control device 100 according to the first embodiment is configured such that when the circuit power source P1 is lowered or the brake control unit 20a is broken in the first brake control device 100, the contact of the circuit-power-source supply relay 34 is open and braking is automatically generated. According to the brake control device 100 of a second embodiment, the logic of the circuit-power-source supply relay 34 is inverted, so that the brake cylinder pressure 18 is exhausted when the circuit power source P1 is lowered or the brake control unit 20a is broken in the first brake control device 100.

According to the brake control device 100 of the second embodiment, for example, when the circuit power source P1 is lowered or the brake control unit 20a is broken in the first brake control device 100, a contact of the circuit-power-source supply relay 34 is closed. Accordingly, generation of emergency braking despite a driver's intention can be prevented. The brake cylinder pressure 18 corresponding to emergency braking can be also supplied.

Further, when the emergency brake command 12 is output, the circuit power source P2 is not supplied to the RIMV 23 regardless of whether the circuit power source P1 is lowered or the brake control unit 20a is broken in the first brake control device 100. The RIMV 23 thus supplies the brake cylinder pressure 18 corresponding to emergency braking. That is, the brake control device 100 according to the second embodiment is configured to be always operated safely when the emergency brake command 12 is output, similarly to the brake control. device 100 according to the first embodiment.

### Third Embodiment

The brake control device 100 according to the first embodiment is configured to transmit and receive failure information output from each brake control device 100 through the brake network 11 that monitors the state of each brake control device 100. The brake control device 100 according to a third embodiment is configured to transmit and receive failure information output from each brake control device 100 by an existing monitor device mounted on a rail vehicle, instead of the brake network 11.

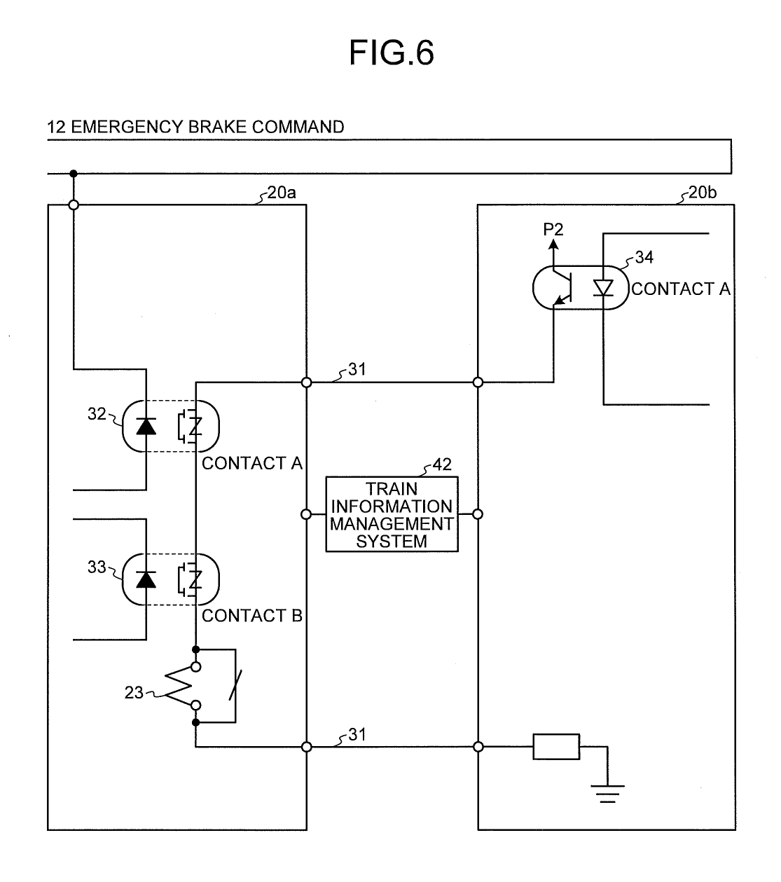

FIG. 6 is an example of a configuration of a brake control unit connected through a train information management system. While only one train information management system 42 is provided in FIG. 6, the train information management systems 42 mounted on respective vehicles are connected to each other by transmission paths (not shown) laid between the vehicles, so that the state of the brake control device 100 mounted on each truck is monitored.

When the brake control device 100 according to the third embodiment is used, the brake network 11 does not need to be established. Therefore, the cost of facilities for monitoring the state of the first brake control device 100 and the second brake control device 100, and the cost of operating the facilities can be suppressed.

### Fourth Embodiment

While the brake control device 100 according to the first embodiment utilizes the circuit power source P2 supplied from the second brake control device 100, the brake control device 100 according to a fourth embodiment is configured to be capable of also utilizing the circuit power source P1 of the first brake control device 100.

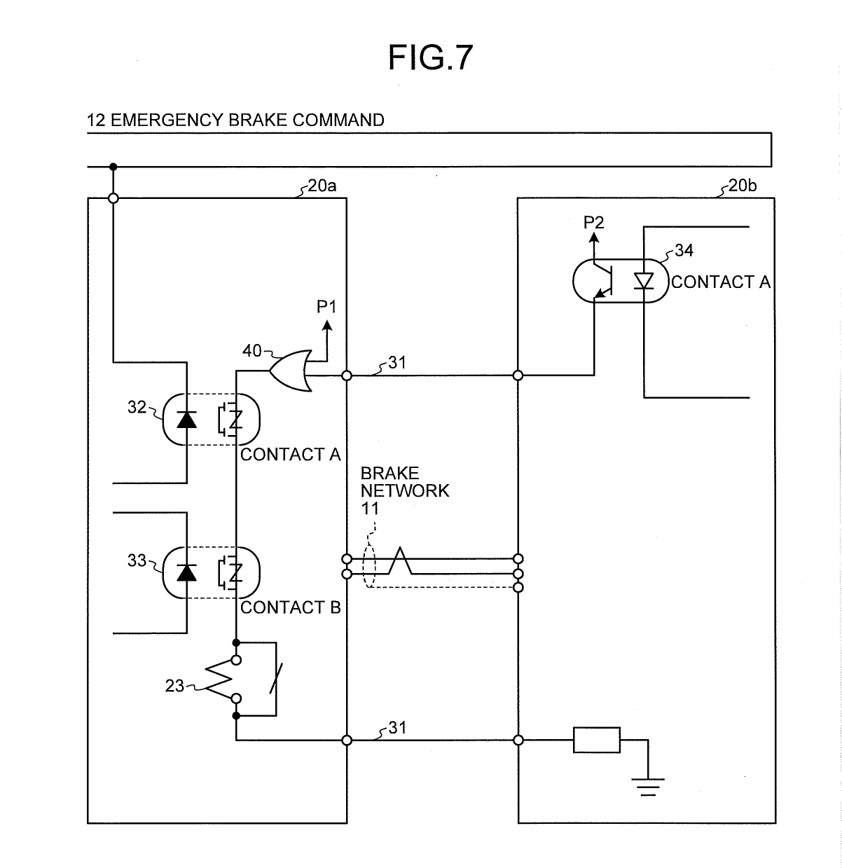

FIG. 7 is an example of a configuration of a brake control unit that includes a circuit-power-source switching unit constituted by an OR circuit. A circuit-power-source switching unit 40 shown in FIG. 7 is constituted by an OR circuit and can switch between the circuit power source P1 of the first brake control device 100 and the circuit power source P2 of the second brake control device 100.

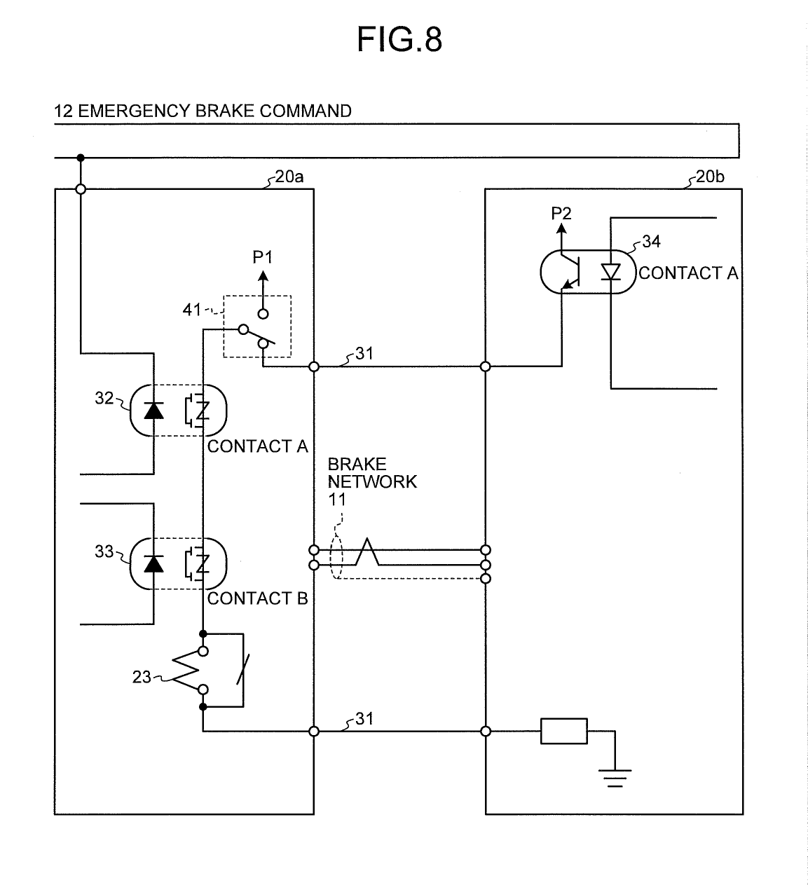

FIG. 8 is an example of a configuration of a brake control unit that includes a circuit-power-source switching unit constituted by a switch circuit. A circuit-power-source switching unit 41 shown in FIG. 8 is composed of a contact switch and can switch between the circuit power source P1 and the circuit power source P2, similarly to the circuit-power-source switching unit 40 shown in FIG. 7.

According to the brake control device 100 shown in FIGS. 7 and 8, when the circuit power source P1 is in a normal state, the power source of the circuit power source P1 is supplied to the RIMV 23 and the brake cylinder pressure 18 for the first brake control device 100 can be controlled. On the other hand, when the circuit power source P1 is lowered, the power source of the circuit power source P2 is supplied to the RIMV 23 and the brake cylinder pressure 18 can be controlled. Therefore, the reliability of the brake control can be further improved.

When the emergency brake command 12 is output, power source supply from the circuit power sources P1 and P2 to the RIMV 23 is stopped regardless of whether the circuit power source P1 is lowered or the brake control unit 20a is broken in the first brake control device 100. The relay valve 24 thus supplies the brake cylinder pressure 18 corresponding to emergency braking. That is, the brake control device 100 according to the fourth embodiment is configured to be always operated safely when the emergency brake command 12 is output, similarly to the brake control device 100 according to the first and second embodiments.

The circuit-power-source switching units 40 and 41 can switch between the circuit power source P1 and the circuit power source P2 in the brake control devices 100 mounted on different vehicles as well as between the circuit power source P1 and the circuit power source P2 in the respective brake control devices 100 mounted on trucks in a same vehicle.

The configuration of the brake control device 100 described in the present invention is only an example of the contents of the present invention. It is needless to mention that the configuration can be combined with other well-known techniques, and the present invention can be configured while modifying it without departing from the scope of the invention, such as omitting a part the configuration.

### INDUSTRIAL APPLICABILITY

As described above, the brake control device according to the present invention is useful for a rail vehicle brake control device that controls a brake cylinder pressure that acts on a brake cylinder based on a service brake command and an emergency brake command.

1-5. (canceled)

6. A rail vehicle brake control device comprising:
a brake control unit that is mounted on each truck and generates a pressure control signal for controlling a brake cylinder pressure that acts on a brake cylinder based on a service brake command and an emergency brake command;
an electromagnetic valve unit that includes a brake control valve that adjusts a pressure of compressed air supplied to the brake cylinder according to the pressure control signal; and
a relay valve that outputs a brake cylinder pressure corresponding to the compressed air supplied from the electromagnetic valve unit, wherein
the electromagnetic valve unit includes a release isolation magnet valve that adjusts a pressure of compressed air supplied to a primary side of the relay valve, and
the release isolation magnet valve is configured to be operated by receiving power source supply from a brake control device mounted on another truck.

7. The rail vehicle brake control device according to claim 6, wherein
even when the brake cylinder pressure is exhausted by the release isolation magnet valve, at a time of emergency braking, a brake cylinder pressure corresponding to emergency braking can be supplied when an emergency brake command is output.

8. The rail vehicle brake control device according to claim 6, wherein
failure information of the brake control unit mounted on each truck can be transmitted and received through a train information management system that manages various pieces of vehicle information.

9. The rail vehicle brake control device according to claim 7, wherein
failure information of the brake control unit mounted on each truck can be transmitted and received through a train information management system that manages various pieces of vehicle information.

10. A rail vehicle brake control device comprising:
a brake control unit that is mounted on each truck and generates a pressure control signal for controlling a brake cylinder pressure that acts on a brake cylinder based on a service brake command and an emergency brake command;
an electromagnetic valve unit that includes a brake control valve that adjusts a pressure of compressed air supplied to the brake cylinder according to the pressure control signal; and
a relay valve that outputs a brake cylinder pressure corresponding to the compressed air supplied from the electromagnetic valve unit, wherein
the electromagnetic valve unit includes a release isolation magnet valve that adjusts a pressure of compressed air supplied to a primary side of the relay valve, and
the release isolation magnet valve is controlled by brake control units mounted on its own truck and another truck, and is operated by receiving power source supply from another brake control unit when the own brake control unit is broken.

11. The rail vehicle brake control device according to claim 10, wherein
even when the brake cylinder pressure is exhausted by the release isolation magnet valve, at a time of emergency braking, a brake cylinder pressure corresponding to emergency braking can be supplied when an emergency brake command is output.

12. The rail vehicle brake control device according to claim 10, wherein
failure information of the brake control unit mounted on each truck can be transmitted and received through a train information management system that manages various pieces of vehicle information.

13. The rail vehicle brake control device according to claim 11, wherein
failure information of the brake control unit mounted on each truck can be transmitted and received through a train information management system that manages various pieces of vehicle information.

14. A rail vehicle brake control device comprising:
a brake control unit that is mounted on each truck and generates a pressure control signal for controlling a brake cylinder pressure that acts on a brake cylinder based on a service brake command and an emergency brake command;
an electromagnetic valve unit that includes a brake control valve that adjusts a pressure of compressed air supplied to the brake cylinder according to the pressure control signal; and
a relay valve that outputs a brake cylinder pressure corresponding to the compressed air supplied from the electromagnetic valve unit, wherein
the electromagnetic valve unit includes a release isolation magnet valve that adjusts a pressure of compressed air supplied to a primary side of the relay valve, and
the release isolation magnet valve is configured to be operated by switching to power source supply from another brake control device when a power source of its own brake control device is broken.

15. The rail vehicle brake control device according to claim 14, wherein
even when the brake cylinder pressure is exhausted by the release isolation magnet valve, at a time of emergency braking, a brake cylinder pressure corresponding to emergency braking can be supplied when an emergency brake command is output.

16. The rail vehicle brake control device according to claim 14, wherein
failure information of the brake control unit mounted on each truck can be transmitted and received through a train information management system that manages various pieces of vehicle information.

17. The rail vehicle brake control device according to claim 15, wherein
failure information of the brake control unit mounted on each truck can be transmitted and received through a train information management system that manages various pieces of vehicle information.
